(19) United States
(12) Patent Application Publication
(10) Pub. No.: US 2008/0189960 A1
(43) Pub. Date: Aug. 14, 2008

(54) Reciprocatory saw, more particularly a jig saw

(76) Inventors: Torsten Reuss, Dettingen/Teck (DE); Volker Kretschmar, Koengen (DE)

Correspondence Address: FLYNN THIEL BOUTELL & TANIS, P.C., 2026 RAMBLING ROAD, KALAMAZOO, MI, 49008-1631, US

(21) Appl. No.: 12/006,885

(22) Filed: Jan. 7, 2008

(30) Foreign Application Priority Data
Feb. 9, 2007 (DE) 102007006481.2

(51) Int. Cl. B27B 19/09

(52) U.S. Cl. 30/392

(57) ABSTRACT

A reciprocatory saw exhibits a drive means for a saw blade to perform a reciprocatory motion. The two side faces of the saw blade are provided with respective guide elements for lateral guidance of the saw blade. The two guide elements are respectively constituted by an eccentric element able to turn about an eccentric member axle, parallel to the longitudinal axis of the saw blade and so loaded by a spring means that the turning of the respective eccentric elements with an increase in the distance between the two eccentric elements takes place against the spring force.

### BACKGROUND OF THE INVENTION

The invention relates to a reciprocatory saw and more especially a jig saw, comprising a drive unit for driving a saw blade, which has two mutually parallel side faces and at its front side is designed for sawing a workpiece, for reciprocatory movement and two guide elements for the two side faces for lateral guidance of the saw blade.

### THE PRIOR ART.

In the case of known reciprocatory saw of this type as described in the German patent publication DE 41 21 989 A1 the guide elements are respectively are arranged at the front end of a support arm and exhibit a plate-like configuration. For adaptation to different saw blade thicknesses the two support arms can be shifted toward and away from one another using a set screw.

Prior to mounting a new saw blade the support arms must be set at such a distance apart that the gap between the guide elements is somewhat wider than the thickness of the saw blade. Following insertion of the saw blade the support arms are then shifted toward each other again so that the guide elements engage the saw blade and may perform their guiding function. This is not only awkward to do but also involves the danger that the guide elements may either be thrust too heavily against the saw blade or leave too much play for it. This will encourage wear or will fail to guide the saw blade accurately.

### SHORT SUMMARY OF THE INVENTION

One object of the invention, taking this prior art as a starting point, is to create a reciprocatory saw of the type initially mentioned in the case of which handling involved for the mounting of a saw blade between the guide elements is to be as simple as possible and in the case of which the saw blade is guide in the firmest possible manner and in a manner with minimum wear.

In order to achieve these and/or other objects appearing from the present specification, claims and drawings, in the present invention the two guide elements are respectively constituted by an eccentric element which is supported to be rotatable about an eccentric element axis parallel to the longitudinal direction of the saw blade, such eccentric element being so rotatably supported for turning about an axis parallel to the longitudinal direction of the saw blade and being so loaded that the turning of the respective eccentric element to increase the distance apart between the two eccentric elements takes place against the spring force.

This means that the guide elements automatically adapt themselves to the thickness of the respectively employed saw blade so that the user does not have to perform any manipulation to set the guide elements. The saw blade is simply thrust in between the two guide elements. The guide elements are so held independently of the thickness of the saw blade that operation takes place practically free of play and the saw blade is held dependably and securely. The spring force may be adjusted quite readily to suit particular needs.

A further advantage is that the eccentric elements may be designed with a comparatively great length, something which increases the accuracy of the guiding action still further.

The eccentric elements in accordance with the invention are comparatively simple to manufacture so that the saw is economic.

Further advantageous developments of the invention are defined in the claims.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 shows the reciprocatory saw of the invention in the form of a jig saw in a foreshortened side elevation, the part of the saw presently of interest being illustrated in a longitudinal section.

FIG. 2 shows the saw blade with the pendulum roller holder and the guide holder in a separate view from the side.

FIG. 3 shows the arrangement of FIG. 2 obliquely.

FIG. 4 shows guide holder in a separate representation as seen obliquely from the front.

FIG. 5 shows the pendulum roller together with guide holder as seen in section and the saw blade in an oblique side view.

FIG. 6 shows the two guide elements constituting the guide elements (without the other guide holders) and the saw blade arranged between them in an oblique view.

FIGS. 7 to 9 show the arrangement of FIG. 6 with saw blades of different thicknesses in an end-on view looking in the direction of the arrow VII in FIG. 6.

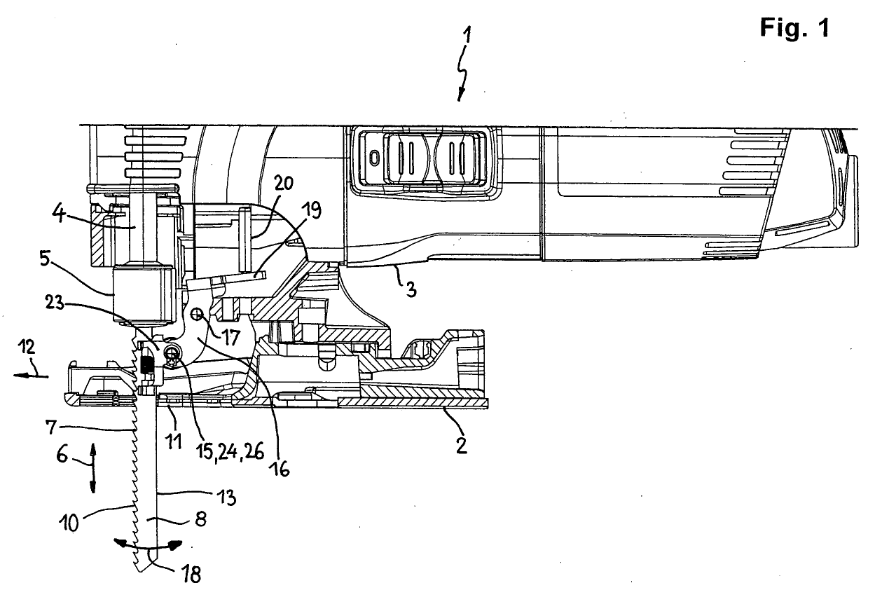

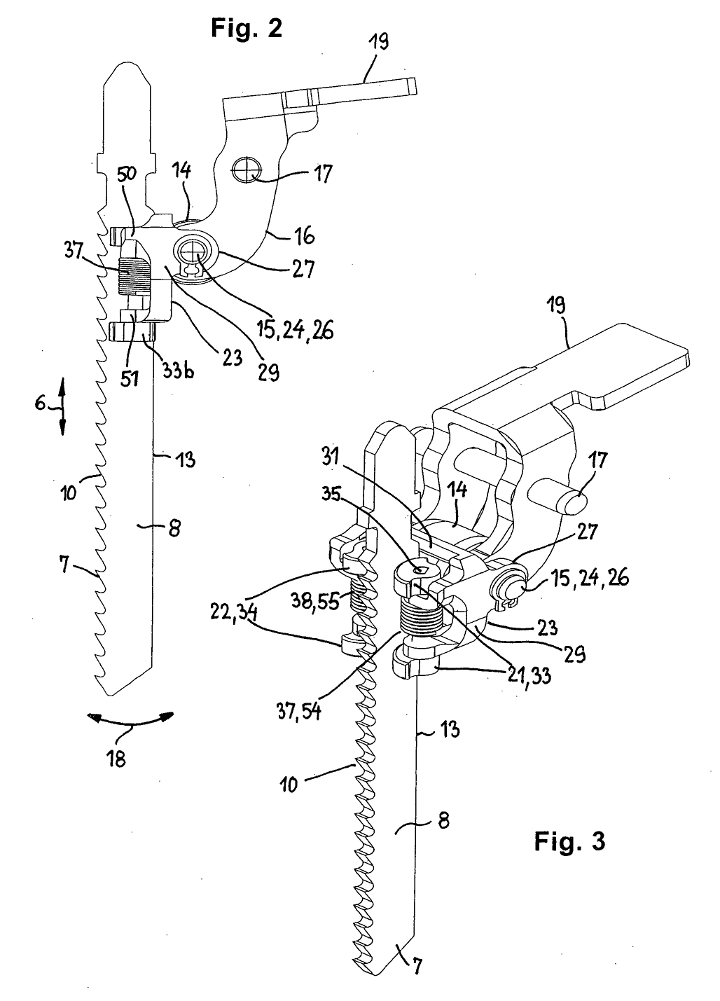

### DETAILED ACCOUNT OF WORKING EMBODIMENT OF THE INVENTION

The jig saw 1 illustrated in the drawings comprises a saw table 2 which is laid against the workpiece (not illustrated) to be sawn using the jig saw. The jig saw 1 furthermore possesses, above the saw table 2, a drive unit 3, which in a conventional manner has a drive motor and a transmission, by way of which a reciprocatory rod 4 having a saw blade holder 5 is driven to perform a reciprocatory movement periodically in accordance with the double arrow 6. The saw blade holder S serves for mounting and remounting a saw blade 7 partaking in the reciprocatory motion and performing the saw cut, such saw blade having two mutually parallel sides facing and which at its front edge 10 is designed for sawing the workpiece and for this purpose has, as illustrated, a row of saw teeth.

The jig saw 1 is in the form of a hand held saw and may be gripped by the user at the housing of the drive unit 3.

At the front end portion of the jig saw 1 the saw blade 7 is arranged and is held, as already mentioned, at its top end portion by the saw blade holder 5. The saw blade 7 extends from the drive unit 3 essentially at a right angle to the saw table 2 downward as far as a position below the saw table 2, which adjacent to the saw blade 7 has a forwardly opening recess 11 in the table for the passage of the saw blade 7. If the jig saw 1 is moved along the workpiece in question in the feed direction 12 forward the saw blade 7 moving upward and downward will saw a slot in the workpiece.

The drive unit 3 is mounted on the saw table 2 and is able to be pivoted about the feed direction 12 and locked in the respective angular setting. The drive unit 3 and with it the saw blade 7 may accordingly be pivoted to the one side or the other side so that the saw blade 7 is directed obliquely to the workpiece and will make a cut therein, for example a miter cut. Further details about the drive unit 3 are not relevant in the present context.

The saw blade 7 has its rear edge 13, which is opposite to the front edge 10, in engagement with a pendulum roller 14 rotatably mounted for turning about a pendulum roller axle 15, such roller 14 being arranged on a pendulum holder 16 which is supported for swinging movement about a pendulum roller axle 17 and which during sawing is driven synchronously with the reciprocatory movement of the saw blade 7 to perform a pendulum motion so that the pendulum roller 14 acts with a pendulum action on the rear edge 13 of the saw blade and the reciprocatory motion 6 of the saw blade 7 is modulated with a pendulum component as indicated by the double arrow 18. In this context it is to be pointed out also that the reciprocatory rod 4 is supported in a pivoting manner in accordance with the pendulum movement. Furthermore the reciprocatory rod 4 and by way of it the saw blade 7 is acted on by spring force directed against the pendulum roller 14.

The roller axle 15 and the pendulum axle 17 are parallel to each other and extend athwart the saw blade 7 past it.

The pendulum roller holder 16 has a lever arm 19 oppositely directed as regards the pendulum axle 17 as related to the pendulum roller 14, such arm being acted upon by a plunger 20, whose upward and downward movement takes place synchronously with the reciprocatory motion 6 of the reciprocatory rod 4.

In order to keep the saw blade 7 running true and not off to the side owing to the workpiece forces occurring the two side faces 8 and 9 of the saw blade 7 respectively have a guide element 21 and 22. Owing to the guide elements 21 and 22 engaging the side faces 8 and 9 of the saw blade there is a lateral guiding action for the saw blade 7 and accordingly a steadying action for it in the transverse direction. The guide elements 21 and 22 are generally at the level of the saw table 2 and in the condition engaging the workpiece are only a little above the it.

The two guide elements 21 and 22 are arranged on a guide holder 23 mounted for pivotal movement about a pivot axle 24 parallel to the pendulum axle 17. The guide holder 23 constitutes a support means 25 associated with the rear edge 13 of the saw blade to engage same during sawing so that the guide holder 23, while maintaining its alignment in relation to the saw blade 7, may perform a reciprocatory pivotal movement corresponding to the pendulum component 18 of the reciprocatory movement of the saw blade 7.

The pivotal axle 24 is placed at the pendulum roller holder 16. It preferably extends coaxially to the roller axle 15 of the pendulum roller 14 so that the pivot axis 24 of the guide holder 23 and the roller axle 15 of the pendulum roller 14—as is the case with the illustrated working embodiment—may be constituted by a common bearing axle 26.

The guide holder 23 possesses two bearing portions 27 and 28 fitting laterally over the pendulum roller 14 so that the pendulum roller 14 is arranged between the two bearing portions 27 and 28. The guide holder 23 is supported on the common bearing axle 26 by means of its two bearing portions 27 and 28.

In accordance with a further convenient feature the guide holder 23 is arranged for movement in the axial direction on the axle 24 bearing it so that it can always automatically align with the saw blade 7.

The pivot axis 24 of the guide holder 23 could in principle be arranged at some other position besides a position coaxial to the pendulum roller. The bearing of the pendulum roller 14 and of the guide holder 23 on the common longitudinal axle 26 is however compact and economic.

The guide holder 23 possesses two side portions 29 and 30 holding the guide elements 21 and 22, which from the side extend past the saw blade 7. Furthermore the support means 25 engaging the rear edge 13 of the saw blade 7 is constituted by two support ribs 31 and 32 of the guide holder 23, such ribs being arranged spaced apart in the longitudinal direction of the saw blade 7 and joining the two side portions 29 and 30 together. In principle only one support rib could be present having such an extent that the guide holder 23 would always be aligned in relation to the saw blade 7 owing to its engagement with it.

The guide holder 23 has its support means 25 resting on the rear side 13 of the saw blade in the longitudinal direction on either side of the saw blade 7.

It will furthermore be seen from the drawing that the bearing portions 27 and 28, by which the guide holder 23 is mounted on its pivot axle 24, are arranged on the side portions 29 and 30 of the guide holder 23.

The two guide elements 21 and 22 are each constituted by an eccentric element 33 and 34 which is rotatably supported about an eccentric element axle 35 and 36 parallel to the longitudinal direction of the saw blade 7 (in this case the eccentric axis line is meant) on the guide holder 23 and is so loaded by a spring means 37 and 38 that the respective force, on turning of the respective eccentric element 33 and 34, becomes larger with an increase in the distance apart of the two eccentric elements 33 and 34. Accordingly the two eccentric elements 33 and 34 are thrust, when the saw blade 7 is inserted, by the spring means 37 and 38 against the side face 8 and 9 of the saw blade 7.

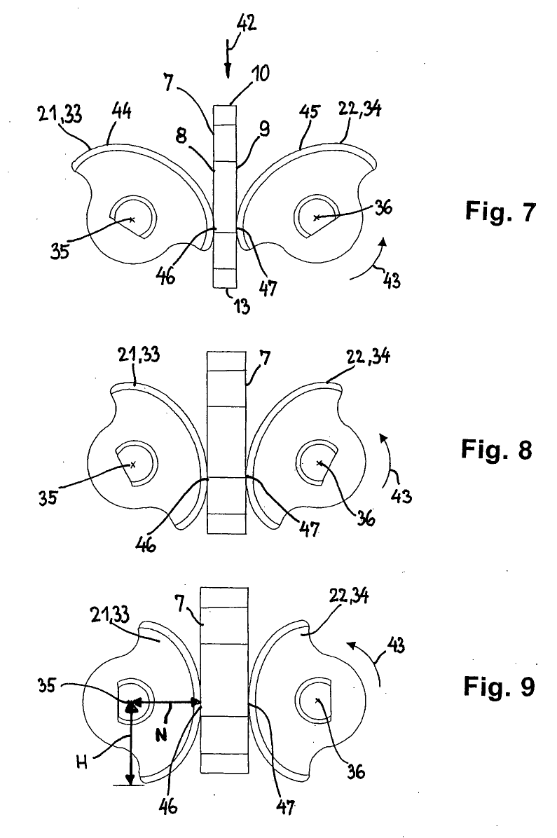

If the saw blade 7 is taken out the two eccentric elements 33 and 34 may respectively engage an abutment 39 and 40 of the guide holder 23 so that the eccentric elements 33 and 34 are opposite each other at a distance apart and delimit a gap 41 for the insertion of the saw blade 7. The gap 41 is narrower than the thinnest saw blade 7 to be employed. The insertion of the respective saw blade 7 takes place from the front in the direction of the arrow 42 (see FIG. 7) with the rear edge 11 of the saw blade to the fore. When the rear side 13 of the saw blade 7 meets with the two eccentric elements 33 and 34 the eccentric elements 33 and 34 will be turned in the direction 43 of turning corresponding to the insertion direction 42 of the saw blade 7 against the spring forces exerted by the spring means 37 and 38 so that the gap 41 for the saw blade is widened out to match the thickness of the respective saw blade 7.

For removal of the saw blade 7 it is pulled out forward out of the gap. The saw blade 7 will slide past the eccentric elements 33 and 34.

It will be clear that the two eccentric elements 33 and 34 respectively have a peripheral face 44 and 45 extending eccentrically in relation to the respective eccentric element axle 35 and 36 and serving for engagement with the saw blade 7. In FIGS. 7, 8 and 9 saw blades 7 with different thicknesses are placed between the two eccentric elements 33 and 34. Here the eccentric elements 33 and 34 are in a different position of rotation dependent on the saw blade thickness so that dependent on the saw blade thickness there is an engagement at a different point on the periphery 44 and 45 with the respective saw blade 7. The connection line between the respective eccentric element axle 35 and 36 and the respective peripheral position 46 and 47 should be as close as possible to an angle of 90 degrees to the side 8 and 9 of the saw blade. For this purpose it is convenient to have a provision such that the peripheral faces 44 and 45 of the eccentric elements 33 and 34 are essentially elliptical, the ratio between the length N of the minor and major axes N and H of the ellipse being less than 0.8. This results in a satisfactory compromise for all saw blade thicknesses coming into question.

The two eccentric elements 33 and 34 may be designed to extend for any convenient distance in the longitudinal direction of the saw blade 7 as far as required so that the saw blade 7 is guided for a suitable longitudinal extent by the eccentric elements 33 and 34. It is however not necessary to provide an eccentric peripheral face 44 and 45 extending along such length. In this connection there is preferably a provision such that the two eccentric elements 33 and 34 each comprise two—in principle more than two would be possible—separate eccentric members 33a and 33b and respectively 34a and 34b arranged along the eccentric element axles 35 and 36, such members being joined together, preferably integrally, by an eccentric axle member 48 and 49 which is supported in a rotatable manner on the guide holder 23.

The guide holder 23 has a bearing arm 50, 51, 52, and 53 axially adjacent to each separate eccentric member 33a and 33b and 34a and 34b so that each eccentric axle member 48 and 49 is mounted rotatably on two of the bearing arms 50 and 51 and, respectively, 52 and 53. The two respective bearing arms 50 and 51 and furthermore 52 and 53 are arranged with an axial spacing between them.

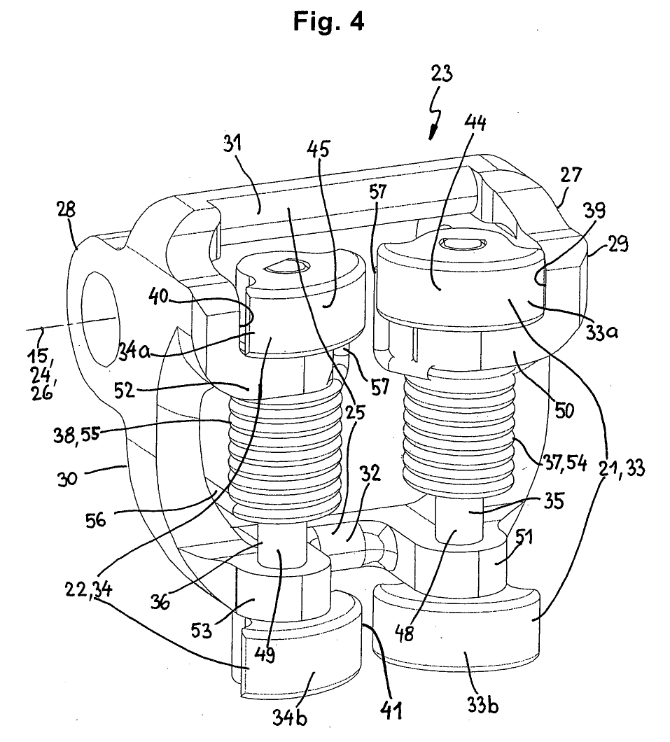

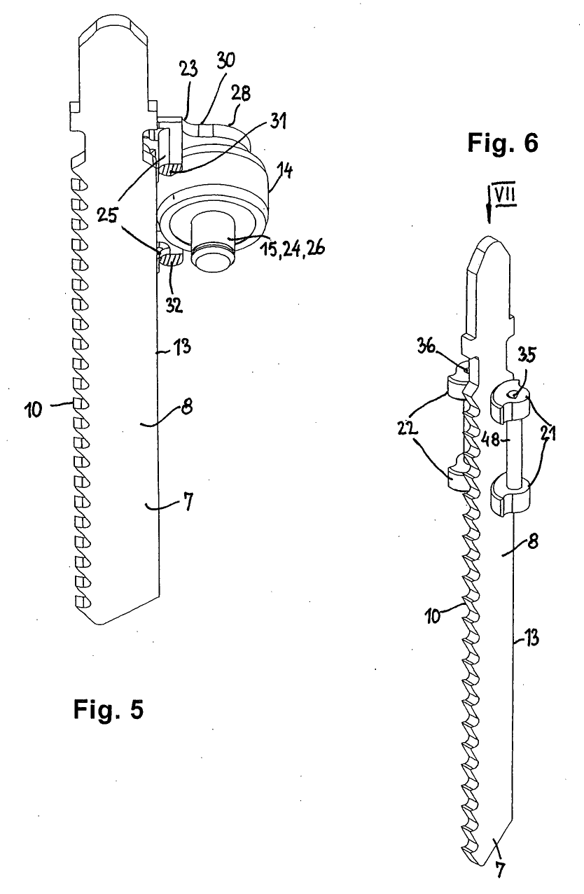

The two spring means 37 and 38 each loading one eccentric element 33 and 34 are best constituted by a helical torsion spring 54 and 55 centered on the axis of the respective eccentric element 35 and 36 and bearing at one end on the guide holder 23 and at the other end on the respective eccentric element 33 and 34. It is to be seen more particularly from FIG. 4 that the respective spring end 56 engages a stationary face of the guide holder 23 and the respective other spring end 57 on the facing separate eccentric member 33a and, respectively, 34a.

The two helical torsion springs 54 and 55 are respectively arranged between the two bearing arms 50 and 51 and respectively 52 and 53 and have the respective eccentric element axle member 48 and, respectively, 49 extending through them.

In the case of the working example described above in detail the two eccentric elements 33 and 34 are provided with guide holders 23 able to pivot about the pivot axis 24 parallel to the pendulum axle 17. The design of the guide elements as eccentric elements has however other applications. The eccentric elements may be employed for reciprocatory saws and more particularly generally in the case of jig saws and therefore also in the case of saws with a stationary support roller instead of the pendulum roller or in the case of saws without a roller supporting the rear side of the saw blade. The eccentric elements may therefore be arranged in a stationary fashion on the saw.

1. A reciprocatory saw and more especially a jig saw, comprising a drive unit for reciprocating a saw blade with an elongated configuration, which has two mutually parallel side faces and at its front edge is designed for sawing a workpiece, for reciprocatory movement and two guide elements for the two side faces for lateral guidance of the saw blade, wherein the two guide elements are respectively constituted by an eccentric element which is supported to be rotatable about an eccentric element axle parallel to the longitudinal direction of the saw blade, such eccentric element being so loaded by spring means that the turning of the respective eccentric element to increase the distance apart between the two eccentric elements takes place against the spring force.

2. The reciprocatory saw as set forth in claim 1, wherein the two eccentric elements respectively have at least two separate eccentric members arranged at a distance apart.

3. The reciprocatory saw as set forth in claim 2, wherein the separate eccentric members are fixedly joined together by a rotatably supported eccentric axle member.

4. The reciprocatory saw as set forth in claim 1, wherein the two eccentric elements define a receiving gap for the insertion of such a saw blade with its rear end to the fore, the receiving gap becoming wider on turning the eccentric elements in a direction corresponding to the insertion direction of the saw blade against the forces.

5. The reciprocatory saw as set forth in claim 1, wherein the respective spring means is constituted by a helical torsion spring centered on the axis of the respective eccentric elements, such spring bearing at one end against a stationary means and at the other end against the eccentric element.

6. The reciprocatory saw as set forth in claim 5, wherein the two helical torsion springs each have the eccentric axle member of the respective eccentric element extending through them and bear against one of the separate eccentric members of the eccentric element.

7. The reciprocatory saw as set forth in claim 1, wherein absent a saw blade the eccentric elements are respectively held by the spring force against a stationary abutment.

8. The reciprocatory saw as set forth in claim 1, wherein the two eccentric elements respectively possess a peripheral face essentially corresponding to an ellipse, the ratio between the minor axis length to the major axis length of the ellipse being smaller than 0.8.

9. The reciprocatory saw as set forth in claim 1, wherein the two eccentric elements are arranged on a guide holder constituting a support means associated with the rear side of the saw blade to engage same during operation.

10. The reciprocatory saw as set forth in claim 9, wherein the guide holder possesses two side portions holding one of the eccentric elements and the support means is constituted by at least one support rib, connecting the two side portions, of the guide holder.

11. The reciprocatory saw as set forth in claim 9, wherein the support means is constituted by two support ribs arranged in the longitudinal direction of the saw blade with a distance between them.

12. The reciprocatory saw as set forth in claim 9, wherein the rear side of the saw blade is provided with a pendulum roller which is placed on a pendulum roller holder adapted to perform a pendulum movement during sawing so that the saw blade and the guide holder is pivotally mounted for movement about a pivotal axis parallel to the pendulum axis and during sawing the guide holder performs a reciprocatory pivotal motion, while maintaining its orientation in relation to the saw blade, such pendulum movement corresponding to the pendulum component of the reciprocatory motion of the saw blade.

13. The reciprocatory saw as set forth in claim 12, wherein the pivotal axis of the guide holder is located at the pendulum roller holder.

14. The reciprocatory saw as set forth in claim 13, wherein the guide holder is coaxial to the pendulum roller.

15. The reciprocatory saw as set forth in claim 14, wherein the pivotal axle of the guide holder and the axle is of the pendulum roller are in the form of a common bearing axis.

16. The reciprocatory saw as set forth in claim 15, wherein the guide holder comprises two bearing portions laterally overlapping the pendulum roller so that the pendulum roller is arranged between the two bearing portions, the guide holder having its bearing portions on the common bearing axis.

17. The reciprocatory saw as set forth in claim 12, wherein the guide holder is arranged for movement along the pivotal axle supporting it.

18. The reciprocatory saw as set forth in claim 12, wherein the guide holder engages the rear edge of the saw blade on either side of the pivotal axle in the longitudinal direction of the saw blade.
